(19) United States
(12) Patent Application Publication
(10) Pub. No.: US 2021/0173118 A1
(43) Pub. Date: Jun. 10, 2021

(54) ENVIRONMENT PREDICTION SYSTEM AND ENVIRONMENT PREDICTION METHOD

(71) Applicant: Toyota Jidosha Kabushiki Kaisha, Toyota-shi Aichi-ken (JP)

(72) Inventors: Masahiro Nishiyama, Toyota-shi (JP); Kenji Tsukagishi, Toyota-shi (JP); Takahisa Kaneko, Toyota-shi (JP)

(73) Assignee: Toyota Jidosha Kabushiki Kaisha, Toyota-shi Aichi-ken (JP)

(21) Appl. No.: 16/997,362

(22) Filed: Aug. 19, 2020

(30) Foreign Application Priority Data
Dec. 6, 2019 (JP) 2019-221271

(51) Int. Cl. G01W 1/00; H04L 29/08; H04W 4/38

(52) U.S. Cl. CPC G01W 1/00; H04W 4/40; H04W 4/38; H04L 67/10

(57) ABSTRACT

In an environment prediction system, environment data is acquired in a plurality of vehicles which are moving objects, and measurement position data is recorded. A collection server of a prediction center collects the environment data in association with the measurement position data. A prediction server of the prediction center performs a spatial environment prediction at a future point in time based on the collected environment data. A result of the environment prediction can be distributed by a distribution server of the prediction center. Examples of the environment prediction include a weather prediction and a distribution prediction of an air pollutant.

### CROSS-REFERENCE TO RELATED APPLICATIONS

This application claims priority to Japanese Patent Application No. 2019-221271 filed on Dec. 6, 2019, which is incorporated herein by reference in its entirety including the specification, drawings and abstract.

### BACKGROUND

### 1. Technical Field

The disclosure relates to an environment prediction system and an environment prediction method that perform an environment prediction at a future point in time.

### 2. Description of Related Art

A large number of vehicles usually travel in an area where people are active.

Japanese Unexamined Patent Application Publication No. 2002-062368 describes a system that acquires operation information of a wiper from a vehicle to collect rainfall information of an area where the vehicle travels. The collected rainfall information is used for statistics, analysis, and the like in addition to being distributed using the Internet, for example.

Japanese Unexamined Patent Application Publication No. 2015-158451 describes that a meteorological observation around a vehicle is performed and that a weather prediction for a future time is further performed based on the observation result.

By the way, meteorological authorities, local governments, research institutes, and the like in each country set a plurality of observation points on the ground and automatically measure a wind direction, a wind speed, a temperature, a precipitation amount, and the like. Data obtained by the measurement is used for grasping environment information including meteorological information and also for predicting weather at a future point in time.

### SUMMARY

The environment data acquired around the vehicle is considered to be affected by a situation around the vehicle. When the effect is ignored, an error will be included in an environment prediction.

The disclosure is to perform a highly accurate environment prediction.

A first aspect of the disclosure relates to an environment prediction system including a collection server configured to collect environment data measured in a plurality of moving objects in association with measurement position data of the moving objects, the collection server includes a data correction unit configured to correct the measured environment data based on the measurement position data, and a prediction server configured to perform a spatial environment prediction at a future point in time based on the corrected environment data and the measurement position data.

In the environment prediction system according to one aspect of the disclosure, the environment data is measured by at least one of an outside air temperature sensor, a humidity sensor, a solar radiation sensor, a camera, a rain sensor, or a glass temperature sensor, which is mounted on the moving object and measures an environment around the moving object.

In the environment prediction system according to one aspect of the disclosure, the environment data is measured by at least one of a smog ventilation sensor, a smoke sensor, or a fine particulate matter sensor, which is mounted on the moving object and measures an environment around the moving object.

In the environment prediction system according to one aspect of the disclosure, the collection server collects the environment data measured in a part of the moving objects that satisfies a collection condition among the moving objects located in a collection target area.

The environment prediction system according to one aspect of the disclosure further includes distribution server for distributing a result of the environment prediction.

In the environment prediction system according to one aspect of the disclosure, the environment prediction performed by the prediction server is a weather prediction.

In the environment prediction system according to one aspect of the disclosure, the environment prediction performed by the prediction server is a distribution prediction of an air pollutant.

A second aspect of the disclosure relates to an environment prediction method including a collection step of collecting environment data measured in a plurality of moving objects in association with measurement position data of the moving objects, a correction step of correcting the measured environment data based on the measurement position data, and a prediction step of performing a spatial environment prediction at a future point in time based on the corrected environment data and the measurement position data.

According to the disclosure, it is possible to use the environment data acquired by the moving object for the environment prediction and then to improve the accuracy of the environment prediction.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing a schematic configuration of an environment prediction system according to an embodiment;

FIG. 2 is a diagram for describing sensors and the like mounted on a vehicle;

FIG. 3 is a diagram for describing a functional configuration of a prediction center;

FIG. 4 is a schematic diagram for describing data collection; and

FIG. 5 is a diagram showing an example of displaying a weather prediction on a navigation system.

### DETAILED DESCRIPTION OF EMBODIMENTS

Embodiments will be described below with reference to drawings. In the description, specific aspects are shown to facilitate understanding. However, these exemplify the embodiment, and various other embodiments may be employed.

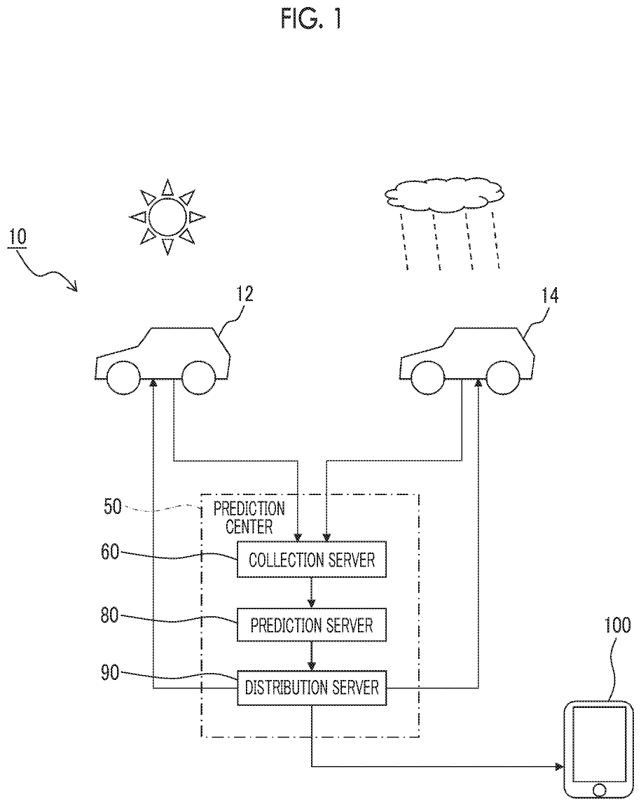

FIG. 1 is a diagram showing a schematic configuration of an environment prediction system 10 according to the embodiment. The environment prediction system 10 is a system that performs a spatial environment prediction in the future for about several minutes to 10 days, such as a weather prediction (sometimes referred to as a weather forecast when it is known to a third party), a distribution prediction of an air pollutant, and the like. The spatial environment prediction refers to the environment prediction having spatial extent such as one-dimensional space (for example, along a latitude line), two-dimensional space (for example, a certain one surface along the ground surface), or three-dimensional space (for example, two or more horizontal planes with different vertical levels), instead of the environment prediction of one point or one spatial average. The environment prediction system 10 includes vehicles 12, 14, a prediction center 50, and a smartphone 100.

Although solely two vehicles 12, 14 are shown in FIG. 1, a large number of vehicles usually travel in an area where people are active. In FIG. 1, the vehicle 12 travels in a sunny area, and the vehicle 14 travels in a rainy area. As described below, the vehicles 12, 14 are equipped with a plurality of sensors, and environment data are acquired by the sensors and transmitted to the prediction center 50. The environment data refers to data indicating the environment around the vehicle. The environment data includes data representing weather states such as clear, cloudy, rainy, and snowy, data representing atmospheric states such as wind speed, wind direction, temperature, and humidity, and data based on states of the sun such as solar radiation amount and illuminance. The environment data also includes data related to rain and snow such as a cloud amount, a precipitation amount, and a snow accumulation amount, and data on air pollutants suspended or contained in the air, such as harmful chemical substance concentrations. The vehicles 12, 14 can receive a distribution of a result of the environment prediction from the prediction center 50.

Other types of moving objects such as an aircraft, a ship, and a drone may be used instead of or in addition to the vehicles 12, 14. The moving object is assumed to refer to a device provided with a moving mechanism. For example, the vehicles 12, 14 are moving objects provided with the moving mechanism configured of wheels and a driving engine or a driving motor, and the aircraft is a moving object provided with the moving mechanism configured of a jet engine, wings, and the like.

The prediction center 50 is installed in a company, a public institution, or the like that performs the environment prediction. The prediction center 50 includes a collection server 60, a prediction server 80, and a distribution server 90. As described below, the prediction center 50 collects the environment data and the like from the vehicles 12, 14, and the like, performs the environment prediction, and distributes the environment prediction result.

The smartphone 100 is a mobile communication terminal used by a general user. The smartphone 100 can receive the distribution of the environment prediction from the prediction center 50 by installing an application program.

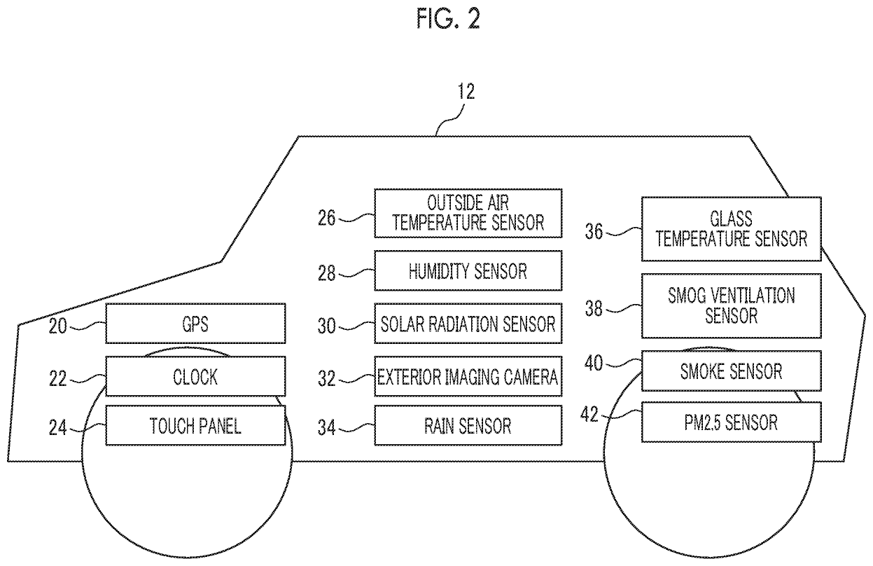

FIG. 2 is a diagram for explaining the vehicle 12 shown in FIG. 1 in detail. The vehicle 12 includes a GPS 20, a clock 22, a touch panel 24, an outside air temperature sensor 26, a humidity sensor 28, a solar radiation sensor 30, an exterior imaging camera 32, a rain sensor 34, a glass temperature sensor 36, a smog ventilation sensor 38, a smoke sensor 40, and a PM2.5 sensor 42.

Among the above, the GPS 20 is an abbreviation for Global Positioning System and is a sensor that detects a position of the vehicle 12 using an artificial satellite.

The detection result by the GPS 20 is used as measurement position data that specifies a position where the environment data measured in the vehicle 12 is measured. This allows the environment data to be treated as a function of position and to be used in the spatial environment prediction. The position of the vehicle 12 during traveling is continuously measured, and thus it is possible to acquire information such as a traveling direction (an angle at which the vehicle 12 faces), a traveling speed, and a traveling inclination of the vehicle 12. For example, the traveling direction of the vehicle is also used to correct the measurement results of various sensors. Further, the GPS 20 can be used to check whether the vehicle 12 is present in a target area where the environment data is collected.

The clock 22 is a device that displays year, month, day, and hour. An output of the clock 22 is used as measurement point in time data that specifies a point in time at which the environment data detected in the vehicle 12 is detected.

The touch panel 24 is a display on which a driver or the like of the vehicle 12 can perform an input operation. A car navigation system can be called on the touch panel 24 to display guidance on a route to a destination. It is also possible to display the environment prediction result distributed from the prediction center 50 on the touch panel 24.

The outside air temperature sensor 26 is a sensor that measures the temperature around the vehicle 12. That is, the outside air temperature sensor 26 acquires temperature data of outside air which is a kind of the environment data. A thermistor or the like can be used as the outside air temperature sensor 26. The outside air temperature sensor 26 is installed, for example, in the vicinity of a front grill provided in a front portion of the vehicle 12.

The vicinity of the front grill is a position that is hardly affected by the heat generated by the vehicle 12. In particular, when the vehicle 12 travels at a speed equal to or larger than a certain level in a state where another vehicle is absent in the surroundings, the temperature of the outside air that is not affected by the host vehicle and other vehicles is detected. On the other hand, for example, when the traffic is congested, the temperature affected by the heat generated by the host vehicle and other vehicles is detected. As described above, the temperature data of the outside air is affected by the traffic condition. Examples of the traffic condition that affect the temperature data of the outside air may include whether or not the vehicle 12 travels on a paved road, whether or not the vehicle 12 travels in an urban area, at what speed the vehicle 12 travels, whether or not the vehicle is stopped, and whether or not there is another vehicle around the vehicle 12. Detection results of other sensors shown below may also be affected by the traffic condition. It is possible to grasp the traffic condition, for example, based on the GPS 20 data or by associating with map data or the like as appropriate.

The humidity sensor 28 is a sensor that measures the humidity around the vehicle 12. That is, the humidity sensor 28 acquires humidity data which is a kind of the environment data. An example of the humidity sensor 28 may include a sensor in which two electrodes sandwiching a humidity sensitive film near a windshield glass are provided and a capacitance change between the electrodes is measured to detect the humidity.

The solar radiation sensor 30 is a sensor that measures the solar radiation amount. That is, the solar radiation sensor 30 acquires solar radiation amount data which is a kind of the environment data. An example of the solar radiation sensor 30 may be a sensor that measures a change in current flowing through a photodiode. The solar radiation amount data can be obtained from the current change in consideration of the angle of the vehicle 12 by the GPS 20 described above and a position of the sun based on the year, month, day, and hour information indicated by the clock 22.

The exterior imaging camera 32 is a sensor that performs imaging in a visible light wavelength band to obtain an image of the outside of the vehicle. The image to be captured may be a still image, but may be a moving image to increase an amount of information. The image captured by the exterior imaging camera 32 generally includes the environment data. Examples of the environment data included in the image include the precipitation amount, the wind speed, the wind direction, a road surface situation (for example, dry or frozen), the snow accumulation amount, the weather (for example, clear, cloudy, rainy, or snowy), and a rain cloud state (for example, where and how much is present). It is possible to acquire the above environment data by analyzing the image. It is also possible to acquire environment data related to the influence of a natural disaster such as an earthquake or a landslide by analyzing the image. A camera in an infrared wavelength band, an ultraviolet wavelength band, or the like may be used as the exterior imaging camera 32, instead of the camera in the visible light wavelength band. For example, it is possible to acquire the temperature data in the surroundings from the captured image when the infrared wavelength band is used.

The exterior imaging camera 32 is also used to grasp the traffic condition around the vehicle 12. For example, when many other vehicles are present around the vehicle 12, the temperature data of the outside air acquired by the vehicle 12 may be slightly heated due to the influence of the vehicles. It is possible to determine whether or not to use the temperature data for the environment prediction, to decide a degree of correction when the temperature data is used for the environment prediction, or the like, by analyzing the image captured by the exterior imaging camera 32.

The rain sensor 34 is a sensor that detects a raindrop amount (and the precipitation amount). That is, the rain sensor 34 acquires raindrop amount data or precipitation amount data which is a kind of the environment data. The rain sensor 34 can be formed, for example, by providing a light emitting diode (LED) that irradiates the windshield glass with infrared light and a photodiode that receives reflected light of the infrared light inside the vehicle. When raindrops adhere to the windshield glass, a part of the infrared light irradiated from the LED is transmitted to the outside of the vehicle through the raindrops and thus an amount of light received by the photodiode is reduced. It is possible to detect the raindrop amount based on the reduced amount. It is possible to correct the raindrop amount according to a change in ambient illuminance by incorporating a light sensor that detects ambient brightness (illuminance) in the rain sensor 34. The raindrop amount is related to the precipitation amount, and it is possible to acquire the precipitation amount data from the raindrop amount data in consideration of a vehicle speed or the like as appropriate.

The glass temperature sensor 36 is a sensor that detects a surface temperature of the windshield glass by a thermistor built in the windshield glass. The temperature of the windshield glass changes depending on the outside air temperature, the solar radiation amount, the traveling speed, a vehicle cabin temperature, and the like. The glass temperature sensor 36 includes the data such as the outside air temperature, the solar radiation amount, and the like which are kinds of the environment data and performs correction processing in consideration of the traveling speed, the vehicle cabin temperature, and the like. Therefore, it is possible to acquire the environment data such as the outside air temperature and the solar radiation amount.

The smog ventilation sensor 38 is a sensor that detects harmful chemical substances such as hydrocarbon (HC), carbon monoxide (CO), and nitrogen oxides (NOx) contained in the outside air. That is, the smog ventilation sensor 38 acquires air pollutant data which is a kind of the environment data.

The smoke sensor 40 is a sensor that detects smoke. The smoke may be generated inside the vehicle, but may also be generated outside the vehicle. It is possible to acquire smoke data in the outside air which is the environment data by detecting the smoke generated outside the vehicle.

The PM2.5 sensor 42 is a kind of a fine particulate matter sensor and is a sensor that detects PM2.5 in the air, that is, a fine particle having a particle diameter of approximately 2.5 μm or less among fine particles suspended in the atmosphere. That is, it is possible to acquire PM2.5 data which is a kind of the environment data by the PM2.5 sensor 42. It is also possible to use, for example, the fine particulate matter sensor having different particle diameters to be detected such as a PM10 sensor, instead of the PM2.5 sensor 42. The fine particulate matter is recently recognized as the air pollutant that adversely affects health.

The above sensors are provided in the vehicle 12 for normal traveling or comfortable traveling. Therefore, there is no need to mount new sensors in particular in order to measure the environment data. However, it is also possible to mount a new sensor on the vehicle 12 in order to measure the environment data. As an example, a pollen sensor that detects pollen such as cedar pollen and cypress pollen may be mentioned. The pollen such as cedar pollen and cypress pollen produces many pollen allergic patients and thus may be an air pollutant.

The vehicle 12 stores the environment data acquired by the sensors. In the storage, the measurement position data indicating the position where the measurement is performed is associated with the measurement point in time data indicating the point in time when the measurement is performed. The stored environment data, measurement position data, and measurement point in time data are transmitted to the prediction center 50 voluntarily from the vehicle 12 or in response to a request from the prediction center 50. It is possible to use, for example, wireless communication such as Wi-Fi (registered trademark) for the transmission.

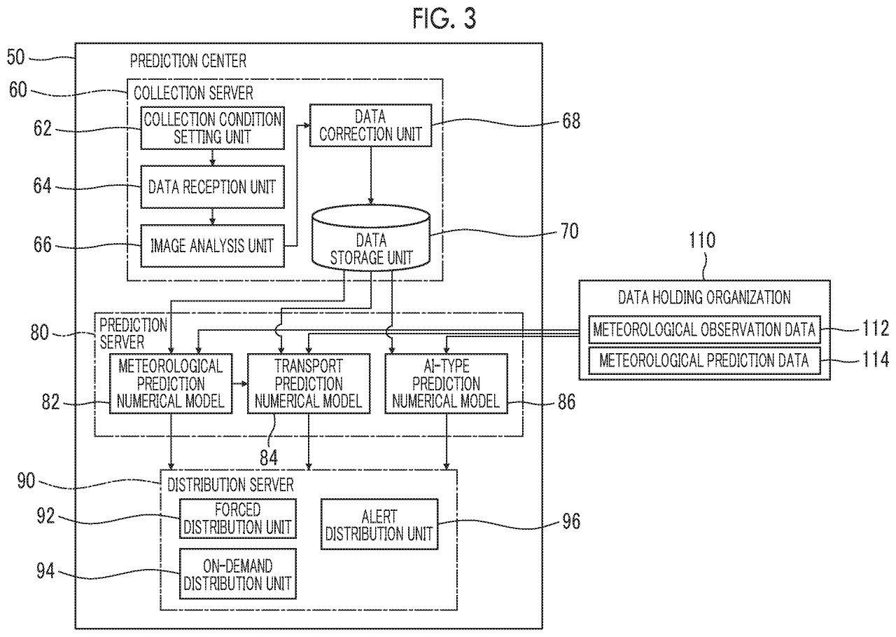

FIG. 3 is a block diagram for describing details of functions of the prediction center 50. The prediction center 50 includes a collection server 60, a prediction server 80, and a distribution server 90. The collection server 60, the prediction server 80, and the distribution server 90 are devices constructed by controlling computer hardware including a memory, a processor, and the like by software such as an operating system (OS) and an application program.

The collection server 60 is an example of a collection means, and a collection condition setting unit 62, a data reception unit 64, an image analysis unit 66, a data correction unit 68, and a data storage unit 70 are constructed under the control of the application program.

The collection condition setting unit 62 is for setting a condition for a target for which the environment data is collected. The collection condition may be set by an administrator or automatically based on a program. Examples of the collection condition include setting of a collection target area, setting about collection target vehicles 12, 14 in the area (number of vehicles, vehicle type, traveling speed, and the like), and setting of a type of the environment data to be collected, a measurement point in time, and the like. It is also possible to set the above traffic condition as the collection condition.

The data reception unit 64 acquires the environment data and corresponding measurement position data and measurement point in time data from the vehicles 12, 14, and the like according to the collection condition set by the collection condition setting unit 62.

It is also possible to acquire traveling speed data at the time of measurement as needed. The environment data to be collected may be selected according to the collection condition after a large number of environment data are acquired.

The image analysis unit 66 performs image analysis when the collected environment data includes the image of the exterior imaging camera 32. The image analysis is performed based on, for example, a learning algorithm. It is possible to grasp the precipitation amount, the wind speed, the wind direction, the road surface situation, the snow accumulation amount, the weather, the rain cloud state, and the like around the vehicles 12, 14 by the image analysis. The traffic conditions around the vehicles 12, 14 are also grasped.

The data correction unit 68 is an example of a correction means and performs correction on the collected environment data for use in the environment prediction. The correction can be performed in various ways. The data correction unit 68 can correct the collected data based on the measurement position data. Examples of the correction based on the measurement position data include a correction according to an altitude above sea level indicated by the measurement position data, a correction based on a traffic volume of the area indicated by the measurement position data, or a correction according to moving speeds of the vehicles 12, 14 indicated by measured data. The correction according to the altitude above sea level means that the values of the environment data are modified in consideration of changing in values of the temperature, the atmospheric pressure, and the like according to the altitude above sea level. The influence of surrounding vehicles and the like differs depending on an urban area and a suburb, or when the traffic is congested and when the traffic is not congested. Therefore, the correction based on the traffic volume means that the influence is corrected. For example, the temperature measured by the outside air temperature sensor 26 tends to increase as the number of vehicles present in the surroundings increases. Therefore, it is conceivable to correct the temperature to a temperature measured in a state where there is no vehicle in the surroundings.

The correction according to the moving speed means that the correction is performed when the sensors of the vehicles 12, 14 output values depending on the speed, when the influence of the surrounding vehicles on the sensors of the vehicles 12, 14 changes depending on the speed, or the like. For example, when the vehicles 12, 14 travel at high speed, the number of raindrops to be recognized increases and an evaporation amount of the raindrops also increases in the rain sensor 34. It is effective to perform the correction according to the speeds of the vehicles 12, 14. Such a correction can be performed in each of the vehicles 12, 14. However, when the data correction unit 68 performs the correction on the same standard, it is possible to improve the quality of observation data and the accuracy of the environment prediction. The data correction unit 68 can also perform the correction independent of the measurement position. For example, there may be processing of adjusting the value of the solar radiation amount data acquired by the solar radiation sensor 30 based on the angles of the vehicles 12, 14 and the position of the sun.

The data storage unit 70 stores the environment data corrected by the data correction unit 68 in association with the measurement position data and the measurement point in time data.

The prediction server 80 is an example of a prediction means and performs the spatial environment prediction. The prediction server 80 is provided with a meteorological prediction numerical model 82, a transport prediction numerical model 84, and an AI-type prediction numerical model 86 in order to perform the environment prediction. The prediction server 80 is set such that meteorological observation data 112 and meteorological prediction data 114 can be acquired from a data holding organization 110 such as the meteorological authorities through a network. In order to improve the accuracy of the environment prediction, a large amount of data are generally needed. Therefore, the environment prediction is performed using the environment data stored in the data storage unit 70 in addition to the meteorological observation data 112 or the meteorological prediction data 114.

The meteorological prediction numerical model 82 is a numerical model created by discretizing a differential equation system such as atmospheric mechanics and parameterizing a meteorological phenomenon having a resolution or less. For example, in an equation system of a non-hydrostatic system, temporal changes in three-dimensional wind speed, temperature, density, water vapor amount, and the like are described, and the cloud amount, the precipitation amount, radiation, and the like are incorporated as parameters. A global model for performing the meteorological prediction of the whole earth and a regional model for performing the meteorological prediction of a part of the earth are prepared as the meteorological prediction numerical model 82. The meteorological prediction is a form of the environment prediction and is used to predict meteorological states such as weather, temperature, wind direction, and wind speed.

In the meteorological prediction numerical model 82, when the model is solved as time integration with respect to an initial value, the meteorological prediction data obtained by performing the time integration in the past and the newly obtained meteorological observation data are integrated to create a spatial initial value at a certain point in time. A spatial meteorological prediction at a future point in time is performed by integrating the initial value with time. Alternatively, when the meteorological prediction numerical model 82 performs four-dimensional assimilation based on a variational method, variables held in the model are modified to be consistent with the newly obtained meteorological observation data and then the time integration is performed.

In the meteorological prediction numerical model 82, the meteorological observation data 112 acquired from the data holding organization 110 is used as the newly obtained meteorological observation data, in addition to the spatially distributed environment data stored in the data storage unit 70. The meteorological observation data 112 acquired from the data holding organization 110 includes data obtained by an artificial satellite, a meteorological radar, and the like, in addition to data such as temperature, wind direction, wind speed, rain amount, and solar radiation observed at a ground observation point. Further, when the meteorological prediction numerical model 82 is the regional model, the meteorological prediction data 114 provided by the data holding organization 110 may be used as a boundary condition.

The meteorological prediction for about several minutes to 10 days is performed by integrating the meteorological prediction numerical model 82 with time. Since the meteorological prediction numerical model 82 can use the detailed environment data collected from the vehicles 12, 14, and the like, the accuracy is improved.

The transport prediction numerical model 84 is a numerical model in which spatial transport of various substances including the chemical substance such as NOx and a natural substance such as pollen is described in an atmospheric mechanics manner. The transport prediction numerical model 84 can be used for spatial distribution prediction of the air pollutant, which is a form of the environment prediction. An advection equation of the substance including a generation term and an annihilation term is discretized in the transport prediction numerical model 84. The wind speed obtained by the meteorological prediction numerical model 82 or the wind speed of the meteorological prediction data 114 of the data holding organization 110 is used as the wind speed for advection.

For example, it is possible to perform the spatial distribution prediction of PM2.5 in the future by using the transport prediction numerical model 84. That is, it is possible to predict what substance concentration will be in what area at what point in time. When PM2.5 data, to be measured by the vehicles 12, 14, having a high spatial resolution is incorporated, the advection result can also be expressed with a high resolution. Therefore, the prediction accuracy can be expected to be improved.

In the transport prediction numerical model 84, it is possible to perform the spatial distribution prediction for the air pollutant such as the chemical substance measured by the smog ventilation sensor 38 or the smoke measured by the smoke sensor 40.

The AI-type prediction numerical model 86 is a prediction numerical model based on artificial intelligence (AI). The AI-type prediction numerical model 86 learns a causal relationship between the measured data and the prediction data based on an algorithm using deep learning or the like to perform the environment prediction at a future point in time.

The meteorological observation data 112, provided by the data holding organization 110, at a certain point in time, and the meteorological prediction data 114 predicted based on the meteorological observation data 112 are considered as an example of the environment prediction by the AI-type prediction numerical model 86. In the case, it is possible to modify the future meteorological prediction data 114 based on a difference between the meteorological observation data 112 at a certain point in time and the environment data stored in the data storage unit 70 at the point in time, in the AI-type prediction numerical model 86.

The AI-type prediction numerical model 86 can be used for both the spatial meteorological prediction and the spatial distribution prediction of the air pollutant. The AI-type prediction numerical model 86 is expected to contribute to the improvement of prediction accuracy particularly in the environment prediction after a short time (for example, after about five minutes to three hours) in which empirical knowledge is likely to work effectively.

The meteorological prediction numerical model 82, the transport prediction numerical model 84, and the AI-type prediction numerical model 86 described above exemplify the execution forms of the environment prediction. The environment prediction can be executed by various other methods.

The distribution server 90 is an example of a distribution means and distributes the prediction result by the prediction server 80. The distribution refers to transmitting information to a plurality of users. The distribution server 90 includes a forced distribution unit 92, an on-demand distribution unit 94, and an alert distribution unit 96.

The forced distribution unit 92 forcibly distributes the prediction result even when there is no user request. For example, the forced distribution unit 92 performs the transmission to the vehicles 12, 14 each time the prediction result is obtained. The forced distribution unit 92 performs the transmission to the smartphone 100 in which a dedicated application program is installed, each time the prediction result is obtained.

The on-demand distribution unit 94 distributes the prediction result when there is a request from the terminal. For example, the on-demand distribution unit 94 distributes the prediction result when the user performs a special operation on the touch panels 24 of the vehicles 12, 14. The on-demand distribution unit 94 distributes the prediction result when the user instructs the smartphone 100 to display the environment prediction.

The alert distribution unit 96 transmits alert information to a target user when a preset condition is satisfied. For example, the alert information is distributed when a thundercloud causing bad weather approaches a location of the user or when a large amount of cedar pollen approaches the location of the user.

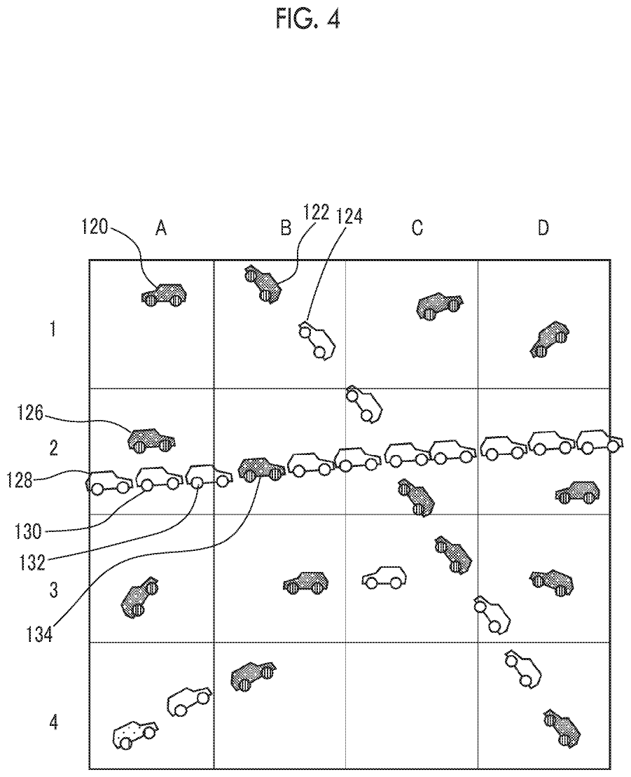

FIG. 4 is a diagram for describing a process in which the collection server 60 collects the environment data. In FIG. 4, a part of a collection target area set by the collection condition setting unit 62 is schematically illustrated. The collection target area is divided into small areas consisting of four vertical columns indicated by A, B, C, and D and four horizontal rows indicated by 1, 2, 3, and 4. A size of the small area is decided according to, for example, the spatial resolution at which the prediction server 80 performs the environment prediction.

In the example shown in FIG. 4, collection conditions of selecting one vehicle and collecting the environment data are assumed to be imposed in each small area.

In a small area of A1 on the upper left, solely one vehicle 120 travels and the vehicle 120 is selected as the collection target of the environment data. FIG. 4 illustrates that the vehicle 120 is selected by the shade. The selected vehicle 120 is assumed to travel on a road having a relatively small traffic volume at a certain speed (for example, 40 km/h). Therefore, it is considered that the vehicle 120 can acquire the environment data such as the temperature data with almost no influence of surrounding vehicles. The data correction unit 68 stores the temperature data in the data storage unit 70 without performing the data correction on the temperature data.

In a small area of B1, it is assumed that two vehicles 122, 124 are assumed to smoothly travel on a main road at a relatively high speed (for example, 60 km/h). Since solely two vehicles 122, 124 travel in the area B1, solely one vehicle 122, which is one of the vehicles, is selected as the collection target. The traffic volume is heavy on the main road, and thus the presence of the surrounding vehicles may affect the environment data such as the temperature data. However, it is assumed that the vehicle 122 travels at a relatively high speed and an inter-vehicle distance is far away to some extent. Therefore, the data correction unit 68 performs a slight correction on the temperature data or does not perform the correction.

In a small area of A2, it is assumed that the vehicle 126 travels relatively slowly (for example, 30 km/h) on a road with a low traffic volume, and vehicles 128, 130, and 132 travel on a main road at a speed that is slightly congested (for example, 15 km/h). The environment data such as the temperature data is easily affected by surrounding vehicles on a congested main road. In the small area of A2, the vehicle 126 traveling on the road with a low traffic volume is selected.

On the other hand, in a small area of B2, all vehicles travel on the main road with slight congestion and a vehicle 134, which is one of the vehicles, is selected. The temperature data acquired by the vehicle 134 is considered to have a slightly high value due to an influence of the surrounding vehicles (further, influence of the host vehicle). The data correction unit 68 performs correction processing of slightly lowering the temperature on temperature data collected from the vehicle 134 and stores the temperature data in the data storage unit 70.

As described above, the environment data is collected in consideration of the traffic condition such as the traveling speed or density of the surrounding vehicles, and thus it is possible to improve the quality of the environment data. Further, when the environment data is collected from vehicles having different traffic conditions, the data correction unit 68 corrects the environment data. Therefore, it is possible to improve the quality of the environment data.

There is no vehicle traveling in a small area of C4 in FIG. 4. For example, there may be no vehicle traveling in a mountain area, a desert area, a sea area, or the like. There may be a state in which there is a vehicle that is not activated (a state in which the engine or the driving motor is not activated), but there is no traveling vehicle (in other words, vehicle that is activated). The environment measurement by the sensor is not performed generally in the vehicle that is not activated. In the above cases, the environment data is not collected from the vehicle.

It is possible to set the collection condition other than the example shown in FIG. 4. For example, it is considered that a plurality of vehicles in each small area or all vehicles in the small area are selected to collect the environment data and an average value or a median value of the collected values of the environment data is set as the value of the environment data in the small area. Accordingly, it is possible to achieve homogenization of the environment data while a small-scale disturbance is ignored. It is also conceivable to preferentially collect the environment data from a vehicle traveling in a place near a calculation grid in the prediction server 80. Accordingly, a calculation error is expected to be reduced. Further, the environment data may be collected solely for a specific vehicle type made by a certain manufacturer, for example. Accordingly, it is possible to reduce the error in the environment data due to the difference in the sensor.

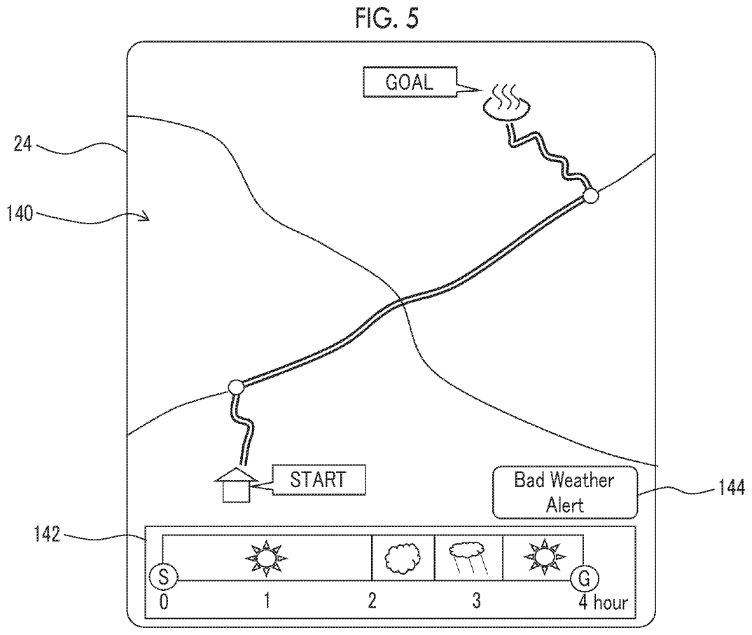

Subsequently, a display example of the environment prediction data distributed by the distribution server 90 will be described with reference to FIG. 5. FIG. 5 is a diagram showing a display example on the touch panel 24 of the vehicle 12.

A car navigation system 140 is activated on the touch panel 24. A driver selects own home as a departure place (START) and a hot spring as an arrival place (GOAL). As a result, the car navigation system 140 displays a travel route with double lines.

The car navigation system 140 is linked with an environment prediction system. When the travel route is set in the car navigation system 140, the car navigation system 140 requests the on-demand distribution unit 94 of the distribution server 90 to distribute the weather prediction. That is, each position which is the travel route and a scheduled travel point in time are transmitted to the on-demand distribution unit 94 to acquire a corresponding meteorological prediction result.

A small window 142 displayed at the lower portion of the touch panel 24 displays a distribution result of the weather prediction. The small window 142 displays information on a scheduled travel time and a weather forecast when the vehicle travels on the selected travel route. Specifically, a scheduled time requested from the departure place to the arrival place is displayed as four hours. The small window 142 displays that the weather is sunny from departure to 2 hours later, cloudy from 2 hours later to 2 hours 40 minutes later, rainy from 2 hours 40 minutes later to 3 hours 15 minutes later, and sunny again from 3 hours 15 minutes later until arrival.

The weather forecast can be displayed in various ways. For example, instead of the small window 142 or together with the small window 142, a color according to the weather forecast may be displayed on a map displayed by the car navigation system 140. Accordingly, it is possible to visually grasp what kind of weather is at which position on the route.

In FIG. 5, a bad weather alert button 144 written as “Bad Weather Alert” is also displayed at the upper right of the small window 142. The bad weather alert button 144 is a button for receiving in advance information about an event defined as bad weather (for example, heavy rain, thunder, tornado, or snowfall).

When the bad weather alert button 144 is pressed, the car navigation system 140 periodically transmits position information of the vehicle 12 and an alert distribution request to the alert distribution unit 96 of the distribution server 90. The alert distribution unit 96 grasps an area where the bad weather is expected based on the latest weather prediction. The alert distribution unit 96 monitors whether or not a scheduled travel position of the vehicle 12 is in a bad weather expectation area. When the position thereof is in the area, the alert distribution unit 96 distributes the fact to the vehicle 12.

When the distribution of the bad weather alert is received, the vehicle 12 displays, on the touch panel 24, an area and a point in time when the bad weather is expected. Accordingly, the vehicle 12 can change the travel route or stop at a facility where a rest can be taken, as needed. The bad weather alert may be distributed immediately when the bad weather is expected or may be distributed when an encounter with the bad weather is certain to some extent such as two hours before or one hour before the bad weather is expected.

The distribution of the environment prediction shown in FIG. 5 is not limited to the vehicle 12 and can be similarly performed for the smartphone 100, a personal computer (PC), and the like.

In the above description, the image analysis unit 66 of the collection server 60 analyzes the environment data acquired by the vehicle, and the data correction unit 68 performs the processing such as the data correction. However, one or both of the image analysis and the data correction may be performed in the vehicle. In the case, the data amount to be transmitted from the vehicle to the collection server 60 may be reduced while the information processing in the vehicle is increased.

What is claimed is:

1. An environment prediction system comprising:
a collection server configured to collect environment data measured in a plurality of moving objects in association with measurement position data of the moving objects the collection server includes a data correction unit configured to correct the measured environment data based on the measurement position data; and
a prediction server configured to perform a spatial environment prediction at a future point in time based on the corrected environment data and the measurement position data.

2. The environment prediction system according to claim 1,
wherein the environment data is measured by at least one of an outside air temperature sensor, a humidity sensor, a solar radiation sensor, a camera, a rain sensor, or a glass temperature sensor, which is mounted on the moving object and measures an environment around the moving object.

3. The environment prediction system according to claim 1,
wherein the environment data is measured by at least one of a smog ventilation sensor, a smoke sensor, or a fine particulate matter sensor, which is mounted on the moving object and measures an environment around the moving object.

4. The environment prediction system according to claim 1,
wherein the collection server is configured to collect the environment data measured in a part of the moving objects that satisfies a collection condition among the moving objects located in a collection target area.

5. The environment prediction system according to claim 1, further comprising:
a distribution server configured to distribute a result of the environment prediction.

6. The environment prediction system according to claim 1,
wherein the environment prediction performed by the prediction server is a weather prediction.

7. The environment prediction system according to claim 1,
wherein the environment prediction performed by the prediction server is a distribution prediction of an air pollutant.

8. An environment prediction method comprising:
a collection step of collecting environment data measured in a plurality of moving objects in association with measurement position data of the moving objects;
a correction step of correcting the measured environment data based on the measurement position data; and
a prediction step of performing a spatial environment prediction at a future point in time based on the corrected environment data and the measurement position data.

9. The environment prediction method according to claim 8,
wherein the environment data is measured by at least one of an outside air temperature sensor, a humidity sensor, a solar radiation sensor, a camera, a rain sensor, or a glass temperature sensor, which is mounted on the moving object and measures an environment around the moving object.

10. The environment prediction method according to claim 8,
wherein the environment data is measured by at least one of a smog ventilation sensor, a smoke sensor, or a fine particulate matter sensor, which is mounted on the moving object and measures an environment around the moving object.

11. The environment prediction method according to claim 8,
wherein the collection step collects the environment data measured in a part of the moving objects that satisfies a collection condition among the moving objects located in a collection target area.

12. The environment prediction method according to claim 8, further comprising:
a distribution step of distributing a result of the environment prediction.

13. The environment prediction method according to claim 8,
wherein the environment prediction is a weather prediction.

14. The environment prediction method according to claim 8,
wherein the environment prediction is a distribution prediction of an air pollutant.

15. The environment prediction method accord to claim 8,
wherein the collection step is performed by a collection server,
wherein the correction step is performed by a data correction unit of the collection server, and
wherein the prediction step is performed by a prediction server.
